(19) United States
(12) Patent Application Publication
(10) Pub. No.: US 2016/0373798 A1
(43) Pub. Date: Dec. 22, 2016

(54) COMMUNICATION METHOD FOR AN INTERACTIVE APPLICATION BETWEEN TERMINALS IN A SCREEN PROJECTION ROOM

(71) Applicant: HIGHLANDS TECHNOLOGIES SOLUTIONS, Valbonne (FR)

(72) Inventor: Sylvain Borgogno, Nice (FR)

(21) Appl. No.: 14/898,946

(22) PCT Filed: Feb. 28, 2014
(86) PCT No.: PCT/FR2014/050451

§ 371 Date: Dec. 16, 2015

(30) Foreign Application Priority Data
Jun. 20, 2013 (FR) 13 55886

(51) Int. Cl. H04N 21/414; H04N 21/41; H04N 21/488; H04N 21/475; H04N 21/81; H04N 21/2668; H04N 21/214; H04N 21/258

(52) U.S. Cl. CPC H04N 21/41415; H04N 21/2143; H04N 21/4126; H04N 21/25833; H04N 21/4758; H04N 21/812; H04N 21/2668; H04N 21/4882; H04W 88/02

(57) ABSTRACT

An interactive audiovisual field and a communication method for an interactive application between terminals in a screen projection room, wherein each terminal is an interactive node connected to a router associated with a server connected to a cinematographic projection device of the room. The method is organized around the execution of events in order to operate in an asynchronous mode and thereby offering a massively collective real-time intercommunication solution for the synchronization, broadcasting and projection of interactive content in cinemas.

The invention relates to the interactive audiovisual field. The invention relates more particularly to a communication method for an interactive application between terminals in a screen projection room.

In the context where the habits of consuming audiovisual content change with the appearance of mobile communication devices with a screen for displaying audiovisual content, such as a mobile telephone or a digital tablet, the cinematographic business seeks to maintain a certain degree of visitation and to find new levers for growth.

This current digital deployment makes it possible to propose a new film experience that integrates the interactivity between the spectator and the cinema screen, that as such meets the needs of customers, advertisers and professionals in the sector.

This new film experience is today provided by a platform, preferentially able to be installed in an existing digital processing chain, which allows the spectators, via their mobile communication device, to live enjoyable and interactive experiences in real time, such as social games.

A ‘platform’ is defined here as a set of hardware and/or software components able to communicate with each other.

For example, such a platform comprises:
an audiovisual content reader, such as for example movie trailers, advertisements, games, etc.,
a Web server,
a database storing audiovisual content and user accounts, and
a software application installed on each mobile device of a player for the interfacing via a Web browser with the Web server.

The Web server provides a list of services that guarantee not only the management of software applications, of the database and of all of the cinema screens connected to the platform, but also the communication links between these components. The communication system is based on an HTTP protocol in synchronous mode, in such a way that, at each interaction with the software application, a synchronous request is sent to the Web server which processes the information, communicates it to the database, waits for a response from the latter, updates the information, then sends the response to the software application. As such, the communication system remains passive as long as the user does not send a request.

According to this example, knowing that a cinema room can accommodate up to 700 spectators and that a cinema can have about 20 rooms, it must, in order to guarantee an enjoyable and interactive experience and in real time for the players, be able to manage up to 150,000 requests per second. The quality of the experience is impossible to guarantee when a PHP 5.1 communication technology and a synchronous HTTP communication system are used, as is conventionally the case. Indeed, based solely on a synchronous communication system, the following problems appear:
the latency increases linearly according to the number of players, until it becomes visible and degrades the experience,
this latency which can be seen by the players results for the Web server in a substantial increase in the load, which as such limits the potential number of simultaneous players,
the updating of the software interface is performed as a response to a request.

In order to overcome this last disadvantage, a refresh process can be developed, which simulates a request from the software application, but inevitably increases the number of requests to be processed.

This invention aims to improve the situation.

This invention aims more particularly to provide a platform, able to be installed in an existing digital processing chain, for the implementation of the method according to the invention in order to allow spectators, via their mobile communication device, to live enjoyable and interactive experiences in real time, without a degradation in the quality of said experiences, including when the number of simultaneous players exceeds a few tens of individuals.

For this purpose, this invention consists according to a first aspect of a method, moreover in accordance with the preamble hereinabove, wherein each terminal is an interactive node connected to a router associated with a server connected to a cinematographic projection device of the room, with the method comprising the steps implemented by a router that interconnects a plurality of interactive nodes and at least one database and consisting in:
receiving, from an interactive node registered on the database as having subscribed to a publication service, a publication request comprising a notification of an event and at least data for identifying said service,
transmitting, to the database, each publication request received in order to identify at least one interactive node registered on the database as having subscribed to said service of which the identification data is included in the publication request,
receiving, from the database, the identification data of each interactive node identified, and
transmitting, to each interactive node identified, the event notification received for its publication.

As such, the communication method according to the invention proposes a massively collective real-time intercommunication solution for the synchronization, broadcasting and projection of interactive content in cinemas.

According to a particularity, the plurality of interactive nodes comprises a plurality of mobile communication devices and at least one cinematographic projection device.

According to another particularity, the plurality of interactive nodes further comprises an interactive content reader.

According to another particularity, the method further comprises steps consisting in:
receiving, from a mobile communication device, a subscription request comprising data for identifying said device and data for identifying a service provider and/or a cinema chain and/or a cinematographic projection device, in order to subscribe to a publication service associated with at least said service provider and/or to said cinema chain and/or to said cinematographic projection device, respectively,
transmitting, to the database, the identification data of said device and of said service provider and/or of said cinema chain and/or of said cinematographic projection device for registration of said device with said publication service.

According to another particularity, the router is able to distribute the requests that it receives from the interactive nodes between several databases.

According to another particularity, several routers are arranged to interconnect the plurality of interactive nodes and the other components of the communication system.

The method according to one or the other of these last two particularities advantageously makes it possible to increase the processing capacity of concurrent requests.

According to another particularity, the steps of receiving/transmitting are carried out according to an input/output multiplexing protocol.

According to another particularity, the communications received/transmitted are programmed in the Node.js language.

According to another particularity, the database comprises a remote dictionary server.

According to a second aspect, the invention relates to a computer program comprising instructions for the implementation of the method according to any of claims 1 to 9, when this program is executed by a processor.

Other characteristics and advantages of the invention shall appear clearly in the description that is made of them hereinafter, for the purposes of information and in no way limiting, in reference to the annexed drawings, wherein:

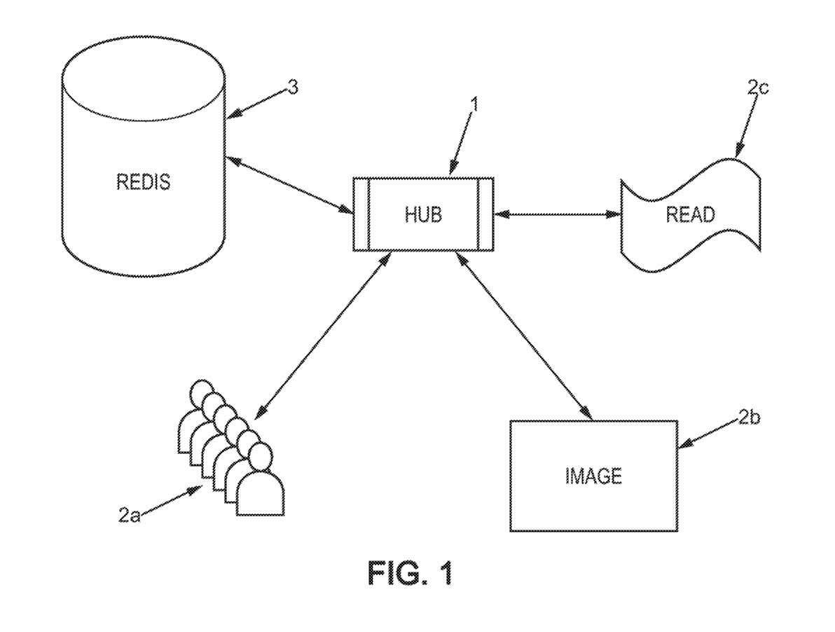

FIG. 1 shows a communication system wherein an embodiment of the method according to the invention is implemented and shows the flow of communication used according to this embodiment,

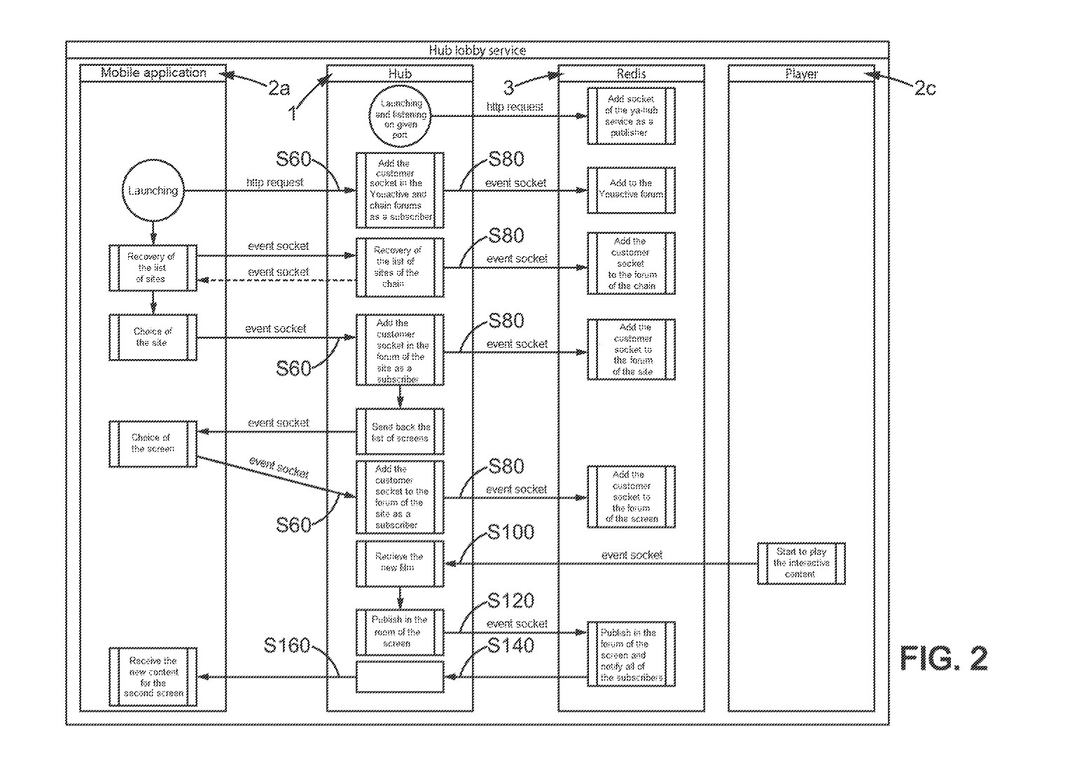

FIG. 2 shows a flowchart of a subscription mechanism according to an embodiment of the method according to the invention,

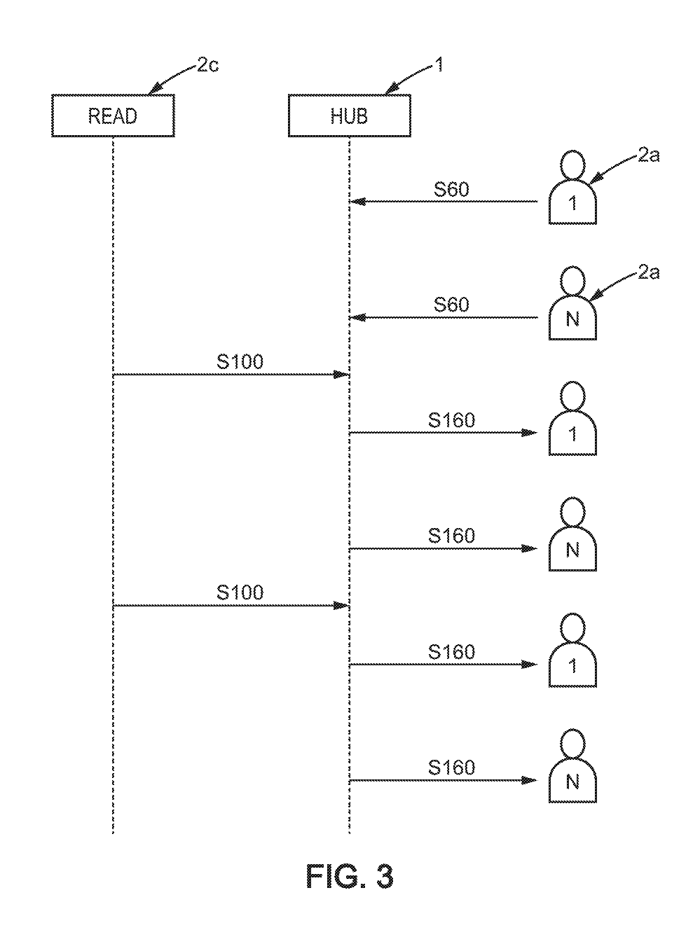

FIG. 3 shows a flowchart of a publication mechanism according to an embodiment of the method according to the invention, and

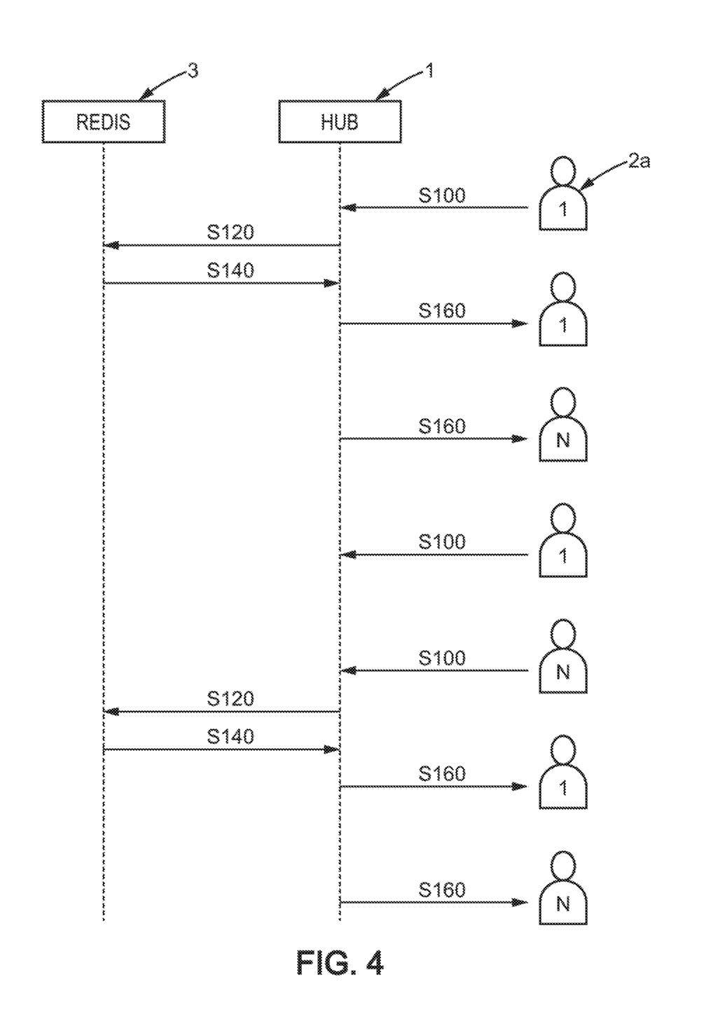

FIG. 4 shows a flowchart of a publication mechanism according to another embodiment of the method according to the invention.

The communication method S according to this invention can be implemented in a communication system such as shown in FIG. 1. This communication system comprises a plurality of interactive nodes 2a and 2b and a communication platform comprising at least one router 1 and at least one database 3.

The plurality of interactive nodes can include a plurality of mobile communication devices 2a and at least one cinematographic projection device 2b.

Each mobile communication device 2a can more particularly be a mobile telephone, preferably of the Smartphone type, or a digital tablet. On each mobile communication device is installed a software application that performs the software interfacing at least with the router for example via a Web browser.

Each cinematographic projection device 2b comprises at least one display device, consisting for example of a projection device for a cinema room screen, or of a television screen, with the latter being for example located in the hall of a cinema. Each cinematographic projection device can furthermore include a DIP (Digital Interactive Player) in order to supply the projection device with the content to be broadcast in the cinema room, and/or a LIP (Lobby Interactive Player) in order to supply the television screen with the content to be broadcast in the hall of the cinema.

The plurality of interactive nodes can furthermore include an interactive content reader 2c. This reader, in that it is not itself a DIP or a LIP, can be any server of a service provider. The service provider can be the provider of the communication system, a cinema chain, an advertiser, etc. The interactive content reader stores an interactive content associated with a given interactive application in order to transmit it via the router 1 to at least one interactive node identified by interrogation of the database according to the method described hereinbelow.

The database 3 can more particularly comprise a remote dictionary server.

The remote dictionary server is a database management system referred to as “key-value”, preferentially that can change and with very high performance. It integrates a connection interface via which it communicates with the router. It makes it possible to manipulate simple data types: character strings, associative tables, lists, sets and ordered sets. It can retain all of the data in random access memory (RAM). This makes it possible to obtain excellent performance by avoiding disc access, which is particularly costly in terms of time. When the size of the data is too large to be held in memory, the remote dictionary server can also use virtual memory. In order to ensure the retaining of data in the case of an incident—as the random access memory is volatile—the remote dictionary server offers the possibility of “capturing” the state of the database in a file. As this technique does not make it possible to guarantee the retaining of the manipulations carried out between two captures, it is also possible to retain a trace of all of these manipulations. In the case of an incident, the base can be restored by re-applying them in order. The remote dictionary server supports replication via a master-slave model for the purposes of resisting breakdowns and distributing the load. All of the transactions must take place via the master instance, but it is possible to do the reading on the slave instances—if however there is no critical need to access updated data with certitude.

The router 1 is the central element of the communication system. It provides the routing by packets of data at least between the network interface of each interactive node and the network interface of the remote dictionary server. It is associated with a server, i.e. it comprises, or equivalently is comprised in, a server that comprises at least one processor for the implementation of the method according to the invention by the execution of a computer program comprising corresponding instructions. This server is connected to at least one screen projection device, or more particularly a film projection device of the room, at least to transmit to it, and possibly control, the audiovisual content to be projected.

More particularly, the router 1 integrates a plurality of network connection interfaces that allow it to communicate with i) each cinematographic projection device, and in particular with the DIP and the LIP, for example via an Ethernet connection, ii) each mobile communication device, for example via a WiFi or 3G network, iii) the remote dictionary server, for example via Internet, and iv) the interactive content reader, for example via Internet or Ethernet.

The router can furthermore communicate with applications that are specific to the cinema, with these applications being managed by equipment such as a TMS (Theater Management System) which make it possible to control all of the digital equipment provided in cinema projection booths, including the lights or curtains, a loyalty card system and a ticketing system.

The router can also access a “cloud”, i.e. a mutualized and virtualized storage space, making it possible to manage content, user accounts, the control of the mobile application and the sending of activity reports.

The router can further provide:
the routing and the security for the virtual machines of the communication system,
the management interface for the applications,
the configuration interface for the services,
the broadcasting as a flow or “streaming” of audiovisual content, and
the logging of a history of the events.

The router 1 recovers the flow of data circulating in the communication system. These flows of data comprise at least the requests issued by the interactive nodes of the communication system and audiovisual content. These flows can furthermore include new interactive software packages selected for the router by the operator of the communication system. The router can further verify on a regular basis if new data is available, download this new data, and acknowledge receipt of it. Inversely, the router can retrieve history logs and other usage information, that may be necessary to send back to the other components of the communication system. Finally, the router can benefit from a cleaning mechanism in order to purge data that has become useless.

The communication system can implement a communication method S according to an asynchronous mode. This mode of communication is defined by opposition to the synchronous mode according to which the communication method consists in waiting for a response before returning its own.

The communication can as such be organized around the execution of events. An event consists in a step of transmitting and/or of receiving a component from one system to another. An event consists for example in the transmission of a request issued by a player from his mobile device via the dedicated software application.

The communication system can furthermore be based on an input/output multiplexing mechanism. This mechanism makes it possible to pass several pieces of information over a single communication channel and to share the same resource between several users. There are two main techniques for multiplexing: time-division multiplexing and frequency-division multiplexing.

The communication system as such makes it possible to increase the processing capacity of concurrent requests, i.e. transmitted simultaneously, which have been issued from the plurality of interactive nodes. Indeed, the router 1 only transmits the requests received to the ad hoc resources, in such a way that the requests are never placed on hold for processing in a queue which can become saturated and therefore delay the communication system resulting in a degradation in the interactive experience for the player. On the contrary, in this configuration, the communication system remains advantageously available pour to receive requests, even during the processing of several other requests.

The communication method S according to the invention implements, based on the communication system described hereinabove, an advantageous publication mechanism that allows the users to live in real time enjoyable and interactive experiences.

In order to benefit from this advantage, it can be asked of any user to subscribe to a corresponding service. The communication method provides for this purpose at least the subscription mechanism consisting in the steps of communication implemented by the router 1 and consisting in:
receiving S60, from a mobile communication device 2a, a subscription request comprising data for identifying said device and data for identifying a cinematographic projection device 2b, in order to subscribe to a service associated at least to said cinematographic projection device, and
transmitting S80, to the remote dictionary server 3, the identification data of said device and of the cinematographic projection device for recording of the subscription of said device to said service, jointly with the identification data of said service.

The subscription request can more largely be sent by any communications device of a user, typically his personal computer at home; the essential is that the identification data be communicated with the subscription request of a mobile communication device via which the user will interact with the communication system, in particular when he is at the cinema.

The router 1 is here again the central point of the communication system and is used to orchestrate the various asynchronous requests issued by the mobile communication devices, the service providers and possibly the cinematographic projection devices. Then, one of the critical functionalities of the router, or of the server that hosts it, is the management of registrations and unsubscribing for the various services that can be accessed. This management consists more particularly in managing the various connections between connection interfaces in such a way as to make it possible to subscribe to or to unsubscribe from said services.

As this here relates to the interactive audiovisual field, said services can be more particularly defined such as stored forums, at least temporarily, in the remote dictionary server.

FIG. 2 shows a particular embodiment of the subscription mechanism, which is described hereinbelow for the purposes of information and is in no way limiting.

After turning on the router 1 configured in listening mode on a given connection port and the opening of a communication connection between the router and the remote dictionary server 3, the subscription mechanism can include the steps implemented by the router and consisting in:
receiving S60, from a mobile communication device 2a, a subscription request to a forum of the provider of the communication system,
transmitting S80, to the remote dictionary server 3, the subscription request for registration of said device with the forum of the provider of the communication system,
loading a first list of film sites of the chain of cinemas that have the communication system implementing the method according to the invention,
transmitting S80, to the remote dictionary server, a subscription request for the registration of said device with the forum of the chain of cinemas,
transmitting, to the mobile communication device, of said first list,
receiving S60, from the mobile communication device, of a choice of a site made by the user from among said first list,
transmitting S80, to the remote dictionary server, said choice of site for registration of said device with a forum of the site chosen,
loading of a list of cinematographic projection devices 2b of the film site chosen,
transmitting, to the mobile communication device, of said second list,
receiving S60, from the mobile communication device, of a choice of cinematographic projection device made by the user from among said second list,
transmitting S80, to the remote dictionary server, of said choice of cinematographic projection device for registration of said device with a forum of said device.

According to this subscription mechanism, the user is as such registered with several forums. Any user registered in the forum of a chosen cinematographic projection device 2b is also registered with the forums of the corresponding film site, of the corresponding chain of cinemas and of the provider of the communication system. Then, he will receive any notification of an event published on these forums.

A prioritizing of the forums is as such advantageously proposed:
the one of the lowest level is the forum of a given screen in a precise cinema and makes it possible to receive the notifications associated with this screen,
the one of the site is the level above that of the one of the screen and makes it possible to receive the notifications from the geographical site,
the one of the chain is the level above the one of the site and makes it possible to receive the notifications from the cinema chain,
the one corresponding to the provider of the communication system is the highest level and makes it possible to receive the notifications from the provider of the communication system, with all of the users that have downloaded and installed the dedicated mobile application being, in the example given, required to be registered with the forum of the provider of the communication system.

Following the subscription of at least one user, an interactive application or experience is implemented by the router 1, which for this purpose can be led to retrieve a corresponding interactive content stored on a specific server 2c. By way of example for the purposes of information and in no way limiting, said audiovisual content can consist of:
a movie trailer contest,
an interactive quiz,
interactive advertising, and/or
a dedication.

The movie trailer contest proposes for example a choice of several movie trailers, and each spectator can vote for their favorite trailer. The number of votes is not limited: a spectator can therefore vote several times for the same trailer, or for other trailers. The results of the votes of the room are displayed in real time on the large screen. The spectator can therefore adapt his vote according to the results displayed.

The interactive quiz consists for example of questions asked of the spectators on the large screen and the spectators provide their answer via their Smartphone (a single response is possible per question). The spectator that correctly answers and the who is the fastest will see the large screen display his pseudo and his avatar, and will have the right to a recompense. He then receives a message that provides him with the instructions to follow to receive his recompense (coupon for a free drink, etc.).

Interactive advertising consists in proposing targeted advertising according to the audience known based on a certain amount of information collected for example during the subscription, with this information comprising for example the geographical origin, sex, age, etc. of each subscriber.

The dedication consists in a personal text (maximum 140 characters) registered on an image chosen by the spectator. The signature is composed of the first name followed by the initial of the last name. A system for moderating makes it possible to ensure the use of vocabulary that is respectful for all.

Such as shown in FIG. 4, the communication method for an interactive application according to the invention then comprises the steps implemented by the router 1 and consisting in:
receiving S100, from an interactive node 2a and 2b registered on the database as having subscribed to a publication service, a publication request comprising a notification of an event and at least data for identifying said service,
transmitting S120, to the database 3, each publication request received in order to identify at least one interactive node registered on the database as having subscribed to said service of which the identification data is included in the publication request,
receiving S140, from the database, a list comprising the identification data of each interactive node identified, and
transmitting S160, to each interactive node identified, the event notification received for its publication.

For example, a spectator that is registered in a forum corresponding to screen no. 1 in the site S, of the chain C, will receive the notifications that correspond to screen no. 1, and those published in the forums of the site S, of the chain C and of the provider of the communication system. All of the Smartphones of the users registered in the forum of the screen no. 1 are synchronized and receive in real time any new publication that corresponds to this forum.

The information published in the forums can consist of:
information on the films that are currently broadcast in the cinema or on those that will soon be broadcast, with this information taking for example the form of event notifications issued by a publication server of the cinema and received by the mobile communication devices registered with the forum of the site or of the chain,
the opinions of the spectators who have viewed the films, with the possibility of voting in order to give one's own opinion, with these opinions taking for example the form of event notifications issued via the mobile communication devices and received and processed by the router or retransmitted by the router for processing,
a vote for choosing which film will be projected in the largest room during the last broadcast thereof,
a reservation for seats for an upcoming film,
an interactive content transmitted to the mobile communication devices and/or to the cinematographic projection device,
a dedication to be projected on the large screen during the period before the film.

As such, the communication method S according to the invention proposes a massively collective real-time intercommunication solution for the synchronization, broadcasting and projection of interactive content in cinemas.

More particularly, this method is organized around the execution of events in order to operate in an asynchronous mode. According to this mode, each interactive node is informed of each event without it having to have sent a request for this purpose or to wait for a programmed refresh of his mobile application. Then, the necessity for synchronous data exchanges according to prior art is advantageously circumvented, in order to allow in particular the spectators, via their mobile communication device or devices, to live enjoyable and interactive experiences in real time, without degradation of the quality of said experiences, including when the number of simultaneous players exceeds a few tens and even a few hundred individuals.

The method according to the invention is based on a subscription and publication mechanism through which the users subscribe to a forum, wherein any subscriber can publish messages, without knowing which subscriber or subscribers also registered in this forum will receive them. The users receive an event notification at every publication. More particularly, each event notification corresponds to an update of the dedicated software application. Subscribers can register in one or several forums, without knowing the publisher or publishers of them, or when new event notifications will be published. It is no longer the user who goes after the information, as was the case according to synchronous communication methods, but the information that comers to him.

The method according to the invention also makes it possible to have a decentralized and non-geolocalized architecture, and therefore a multi-site multi-user communication. Each subscriber can potentially access all of the information of all of the forums.

In addition, the communication becomes independent of the mode of connection (Wifi, 3G, etc.) and of the equipment used. A user can receive an event notification on his Smartphone, as well as on his digital tablet, his personal computer, his connected television.

The method makes it possible to achieve a communication in real time for the carrying out of a common task and this, without a response delay. The method makes it possible more particularly to have a communication and a collective interactivity of quality, as there is no time interruption between the triggering, the processing and the result of an event.

Through the notification of events to the mobile applications, the updating of the user interface is no longer the consequence of a request, or of a refreshing, but of an independent event generated by the publication of a message in a forum. The method makes it possible to transmit to the user only information that is pertinent and already processed, and therefore to reduce the processing time and latency. When a user subscribes to a forum, the user then becomes available to receive all of the information on all of his connected devices.

According to another particularity, the router is able to distribute the requests that it receives from the interactive nodes between several databases.

According to another particularity, several routers are arranged to interconnect the plurality of interactive nodes and the other components of the communication system.

The method according to one or the other of these last two particularities advantageously makes it possible to increase the processing capacity of concurrent requests or more particularly simultaneous. More particularly, the communication system is advantageously ‘scalable’, i.e. it has the capacity to adapt to a change in the magnitude of the request or equivalently to an increase in the load. Indeed, the decentralization of the platform has for a natural consequence that in order to respond to any increase in the needs, it is sufficient to increase the number of machines used (number of routers and/or number of databases), without modifying the operation of the platform.

In order to illustrate the foregoing, suppose, in reference to FIG. 3, that a spectator subscribes S60 to a forum associated with the screen no. 1, whereon is broadcast a movie trailer A; he can therefore receive S160 on his Smartphone information on this movie trailer A. When a movie trailer B is going to be broadcast on the screen no. 1, the information corresponding to this movie trailer B will be published in the forum of the screen no. 1, and consequently, all of the users 1, N which are registered with this forum will receive S160 on their Smartphone the same information in real time; which is a synchronization between the projection and the emission of event notifications from each cinematographic projection device 2b to the mobile communication devices 2a.

The communication with the router is carried out for example thanks to the Node.js language, which makes it possible to work with the JavaScript language in an asynchronous and event-driven environment. As such, the read or write operations are made parallel and are orchestrated via the router. The passing from a conventional PHP5 HTTP server with synchronous requests to a server in Nodejs based on asynchronous and event-driven requests makes it possible to substantially increase the number of requests processed by the server, as shown in the comparative table hereinbelow.

| Mode | HTTP/PHP 5 | Node.js |
|---|---|---|
| Number of requests processed | 2500 | 12500 |
| per second | | |

In order to ensure real-time processing and make it possible to notify all of the mobile applications at the same time, the two following technologies are for example used:
“socket.io” is a Node.js module that makes it possible to provide the connection in real time between all of the mobile communication devices connected to the platform,
“Redis” (for “Remote Dictionary Server”), which is the remote dictionary server, is an extremely high-performance database management system of which the main characteristic is to retain all of the data in memory. It manages the forums and the publication/subscription service.

The following table quantifies the resulting improvement in the response time.

| Mode | HTTP/PHP 5 | Nodejs |
|---|---|---|
| Response time in seconds | 0.50 | 0.10 |

This invention is particularly suited to all of the cinema rooms around the world, but also to all of the infrastructures open to the public and broadcasting audiovisual content, such as concert halls, stadiums, shopping galleries, conferences, event projections, learning over the Internet (E-learning), etc.

1. A method of communication for an interactive application between terminals in a screen projection room, wherein each terminal is an interactive node connected to a router associated with a server connected to a cinematographic projection device of the room, with the method comprising the steps implemented by a router interconnecting a plurality of interactive nodes and at least one database and consisting in:
receiving, from an interactive node registered on the database as having subscribed to a publication service, a publication request comprising a notification of an event and at least data for identifying said service,
transmitting, to the database, each publication request received in order to identify at least one interactive node registered on the database as having subscribed to said service of which the identification data is included in the publication request,
receiving, from the database, the identification data of each interactive node identified, and
transmitting, to each interactive node identified, the event notification received for its publication.

2. The method according to claim 1, wherein the plurality of interactive nodes comprises a plurality of mobile communication devices and at least one cinematographic projection device.

3. The method according to claim 2, wherein the plurality of interactive nodes further comprises an interactive content reader.

4. The method according to claim 2, further comprising the steps consisting in:
receiving, from a mobile communication device, a subscription request comprising data for identifying said device and data for identifying a service provider and/or a cinema chain and/or a cinematographic projection device, in order to subscribe to a publication service associated with at least said service provider and/or to said cinema chain and/or to said cinematographic projection device, respectively,
transmitting, to the database, the identification data of said device and of said service provider and/or of said cinema chain and/or of said cinematographic projection device for registration of said device with said publication service.

5. The method according to claim 1, wherein the router is able to distribute the requests that it receives from the interactive nodes between several databases.

6. The method according to claim 1, wherein several routers are arranged to interconnect the plurality of interactive nodes and said at least one database.

7. The method according to claim 1, wherein the steps of receiving/transmitting are carried out according to an input/output multiplexing protocol.

8. The method according to claim 1, wherein the communications received/transmitted are programmed in the Node.js language.

9. The method according to claim 1, wherein the database comprises a remote dictionary server.

10. A non-transitory computer-readable storage medium with an executable program stored thereon, wherein the program instructs a microprocessor to perform the method according to claim 1.
